(19) United States
(12) Patent Application Publication
(10) Pub. No.: US 2012/0278182 A1
(43) Pub. Date: Nov. 1, 2012

(54) GENERATING AN ADVERTISEMENT MESSAGE

(76) Inventors: Niranjan R. Kamath, (US); Hendrik Jacob Hoevelaken, Zeewolde (NL)

(21) Appl. No.: 13/096,017

(22) Filed: Apr. 28, 2011

(51) Int. Cl. G06Q 30/00

(52) U.S. Cl. 705/14.72

(57) ABSTRACT

Implementations disclosed herein relate to generating an advertisement message. In one embodiment, a processor generates an advertisement message that includes an offer and a method for accepting the offer. An acceptance to the offer in the generated advertisement message may be tracked to identify the potential customer accepting the offer.

### BACKGROUND

Electronic advertisements may be used to present information and offers to a potential customer. For example, an advertisement may be emailed to a user where the email provides information about an upcoming sale or information about a new line of available items. A customer may then decide to buy a product or service in response to receiving the advertisement.

### BRIEF DESCRIPTION OF THE DRAWINGS

The drawings describe example implementations. The drawings show methods performed in an example order, but the methods may also be performed in other orders. The following detailed description references the drawings, wherein:

FIG. 1 is a block diagram illustrating one example of a computing system.

FIG. 2 is a flow chart illustrating one example of a method to generate an advertisement including a method for acceptance.

FIGS. 3A and 3B are diagrams illustrating examples of user interfaces for providing a promotional offer and a method of accepting the promotional offer.

FIGS. 4A and 4B are diagrams illustrating examples of user interfaces for providing a promotional offer and a method of accepting the promotional offer.

FIG. 5 is a flow chart 500 illustrating one example of a method to track an acceptance of an offer with an advertisement message.

### DETAILED DESCRIPTION

Advertisements may be tailored to a particular person, such as based on previous purchases or internet searches performed by the person. In some cases, advertisements may be delivered in an automated message formatted, such as through an email, Short Message Service (SMS) message, or interactive voice response (IVR) phone call. In one implementation, an electronic advertisement message includes a promotion and a method of acceptance, such as a method of accepting a promotion by clicking within the message or responding to the message. For example, an SMS message or email may include a link to accept the advertised promotion, such as to buy a product or service at a discount. An acceptance may be tracked using an identifier associated with the advertisement message or based on information related to a device or user account accepting the offer within the message.

Including a method of acceptance within an advertisement message may make it more likely that a receiver of the advertisement may accept the offer in the advertisement because acceptance of the promotion may be simpler and faster. In some cases of promotions on services provided by a telecommunications operator, activating such promotions may involve interaction with several systems. These systems may have different interfaces available for communication, making the activation process more cumbersome and time consuming. Including a method of acceptance within an advertisement message may facilitate acceptance or consumption of the promotional offer to the customer in a shorter amount of time. In addition, the simpler acceptance method may make it easier to accept a marketing promotion from a mobile computing device. Tracking the acceptance with an identifier may allow the acceptance to be processed while requesting minimal additional information from the potential customer accepting the offer.

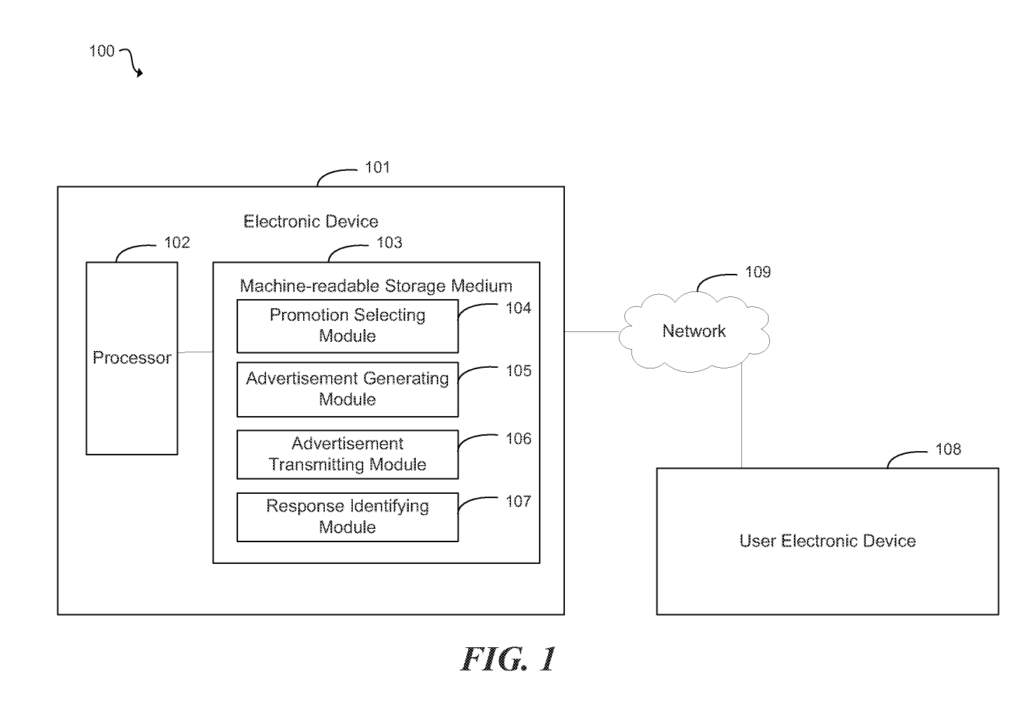

FIG. 1 is a block diagram illustrating one example of a computing system 100. The computing system 100 may be used to create and transmit an advertisement message to a potential customer where the advertisement includes a method for accepting a promotion in the advertisement. The computing system 100 may identify a potential customer using the method to accept the promotion.

The computing system 100 may include, for example, an electronic device 101, a network 109, and a user electronic device 108. The user electronic device 108 may be any suitable electronic device, such as a personal computer, mobile computing device, mobile phone, or television setup box. In some cases, a user may receive communications on the user electronic device 108. For example, a user may receive SMS messages or voice calls on the user electronic device 108. In some implementations, the user may check an account from the user electronic device 108, such as an email or social networking account. The user may receive advertising messages on the user electronic device 108. The user electronic device 108 may receive information from the network 109. The network 109 may be, for example, the Internet or a cell phone data or voice network.

The electronic device 101 may be a server for creating and sending marketing materials. The electronic device 101 may include a processor 102 and a machine-readable storage medium 103. The processor 102 may be any suitable processor, such as a central processing unit (CPU), a semiconductor-based microprocessor, or any other device suitable for retrieval and execution of instructions. In one implementation, the electronic device 101 includes logic instead of or in addition to the processor 102. As an alternative or in addition to fetching, decoding, and executing instructions, the processor 102 may include one or more integrated circuits (ICs) (e.g., an application specific integrated circuit (ASIC)) or other electronic circuits that comprise a plurality of electronic components for performing the functionality described below. In one implementation, the electronic device 101 includes multiple processors. For example, one processor may perform some functionality and another processor may perform other functionality.

The machine-readable storage medium 103 may be any suitable machine readable medium, such as an electronic, magnetic, optical, or other physical storage device that stores executable instructions or other data (e.g., a hard disk drive, random access memory, flash memory, etc.). The machine-readable storage medium 103 may be, for example, a computer readable non-transitory medium. The machine-readable storage medium 103 may include instructions executable by the processor 102. For example, the machine-readable storage medium 103 may include a promotion selecting module 104, an advertisement generating module 105, an advertisement transmitting module 106, and a response identifying module 107.

The promotion selecting module 104 may include instructions for selecting a promotion for a potential customer. For example, the particular promotion may be based on stored data related to the potential customer's activities, such as purchases and searches. The selected promotion may be, for example, an offer for a sale, coupon, or voucher.

The advertisement generating module 105 may include instructions to generate an advertisement message for the selected promotion. The advertisement message may include the promotion and a method for accepting the promotion. The method for accepting may be, for example, a selectable item, such as a uniform resource locator (URL) link or a phone digit. For example, a recipient may click on a link of banner. The advertisement message may be an email message, a social networking message, a voice message, or an SMS message. The advertisement message may be invitation on a webpage or mobile webpage, such as a banner advertisement. In some implementations, the method for accepting may involve a reply to the advertisement message, such as an SMS message reply, an email reply, or a voice response.

The advertisement transmitting module 106 may include instructions to transmit the generated advertisement message from the electronic device to the user electronic device 108 via the network 109. For example, a recorded phone call, SMS message, or email including the advertisement may be sent to the user electronic device 108 or to an account that may be checked on the user electronic device 108. The potential customer may view or listen to the advertisement and decide whether to use the provided method of acceptance.

The response identifying module 107 may include instructions to determine the customer that accepted the offer. For example, an identifier retrieved or received with the acceptance may be used to determine which customer accepted the offer. In some cases, an identifier may be sent with the message that is returned with the acceptance.

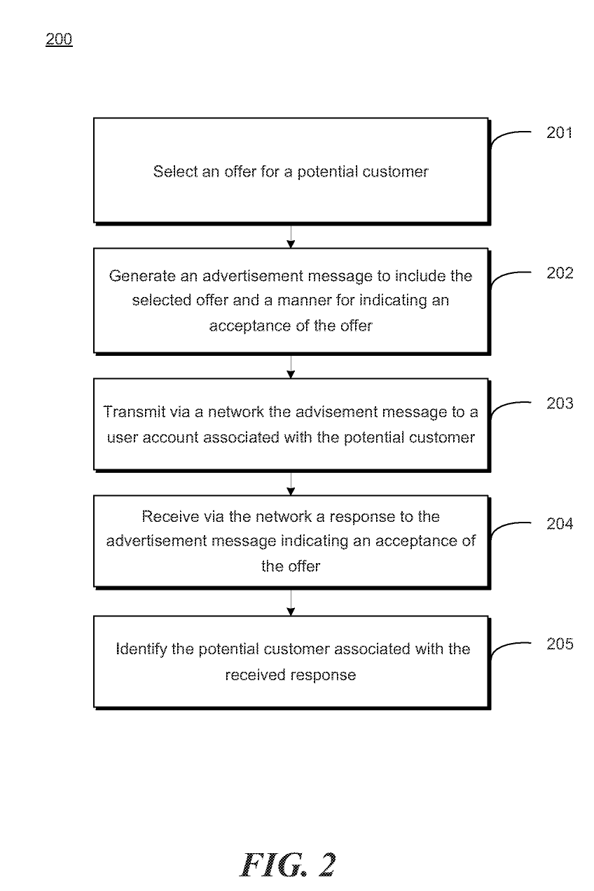

FIG. 2 is a flow chart illustrating one example of a method to generate an advertisement message including a method for acceptance. For example, a processor may select a marketing offer for a customer and generate an advertisement message including the offer. The advertisement message may include a method to accept the offer, such as where a receiver may click within the advertisement to accept or respond to the advertisement to accept. The generated advertisement message may then be transmitted to the potential customer. The processor may receive information via a network indicating the user's acceptance of the offer, such as a user agreeing to purchase a product or service with a discount or accepting a coupon for a product or service. The method may be implemented, for example, by the electronic device 101.

Beginning at 201, a processor selects an offer for a potential customer. In one implementation, the processor is the processor 102 from FIG. 1. The processor may analyze data collected from user input or user monitoring. The information may be compared to characteristics for potential customers likely to be interested in particular offers. In some implementations, the processor selects an offer from a list of possible offers based on collected information related to the potential customer.

The offer may be, for example, an offer to provide a voucher, coupon, or discount or an offer to sell or activate a product or service. The offer may be an offer that involves a commitment from the accepter, such as a commitment to pay for a product or service. In some cases, the offer may be an offer for a coupon where the receiver does not have a commitment to use the coupon if accepted.

Continuing to 202, the processor generates an advertisement message to include the selected offer and a manner for indicating an acceptance of the offer. In some implementations, a separate processor or electronic device may generate the advertisement than the one selecting the offer for the advertisement. The advertisement message may include the information about the offer in any suitable format, such as an email, social networking, banner message, or SMS message with written text about the offer. In some implementations, the advertisement is an audio recording indicating an offer, such as a voice that is heard in a phone call or webcast.

The manner for indicating an acceptance may be, for example, a selectable item within the advertisement message, such as a button or uniform resource locator link within the advertisement user interface. For a recorded voice call, the method of acceptance may be selecting a phone key pad key. The manner for indicating an acceptance may be a reply to the advertisement message. For example, the advertisement message may include instructions for replying to the message to accept. For example, a potential customer may replay to an email, social networking, or SMS message. A potential customer may be asked to say “accept” to accept an advertisement message provided by Interactive Voice Response (IVR).

In some implementations, multiple steps may be involved in accepting the offer. For example, a selectable item may pop up a separate user interface when selected, and a button on the separate pop up may be used to accept the offer. As another example, a user may reply to a message including the advertisement and a follow up confirmation message may be sent to the user requesting a second reply. The advertisement may include instructions indicating the manner for acceptance, such as instructions for a user to reply to an advertisement message with a particular code or to click a particular item displayed within the advertisement. In some cases, multiple options may be provided, such as an advertisement email message that allows the receiver to click a link within the message or reply “Accept” to accept the offer.

Proceeding to 203, the processor transmits via a network the advisement message to a user account associated with the potential customer. For example, a recorded voice message may be played for a potential customer with a particular phone number or an SMS message may be sent to the phone number. In some cases, a textual message may be sent to an electronic account, such as an email or social networking account.

Moving to 204, the processor receives via the network a response to the advertisement indicating an acceptance of the offer. For example, the response may be an automated response sent due to a receiver of an advertisement clicking a uniform resource locator link within an email or SMS message. In some implementations, the response may be a reply to a message containing the advertisement, such as a voice reply to a phone call or replay to an SMS or other electronic message.

Proceeding to 205, the processor identifies the potential customer associated with the received response. In some implementations, the processor receives an identifier associated with the acceptance and determines the potential customer and the offer accepted based on the identifier. For example, an identifier may be the account name or number associated with a reply. The potential customer may be identified by a particular acceptance code provided to the potential customer for including in the reply. In some implementations where an offer is accepted by clicking within the advertisement user interface, clicking results in information about the potential customer and the accepted offer being transmitted to the processor.

In one implementation, an identifier of a device associated with the advertisement message or response is used to track an acceptance. For example, the identifier may be a Mobile Subscriber Integrated Services Digital Network Number (MSISDN) for identifying a subscriber identification module (SIM) card for a mobile device in a mobile phone network. In some implementations, the advertisement message includes a Uniform Resource Identifier (URI) for clicking within the advertisement message to accept the offer, and the Uniform Resource Identifier may include information about an identifier. For example, the Uniform Resource Identifier may be http://accept.com/identifier=CustomerA or http://accept.com/MSISDN=380562183221. The identifier may be appended when the user clicks on the link by capturing the information from the electronic device, or the identifier may be transmitted with the advertisement message to the potential customer. For an SMS advertisement message, header information associated with the SMS message may include the MSISDN information that may be appended to the URI or included in a reply to the advertisement message. For a voice call advertisement message using Interactive Voice Response (IVR), the identifier may be the number dialed to send the voice message.

The processor may identify the customer based on the identifier. For example, the processor may look up the identifier in a storage to retrieve details associated with the identifier, such as the customer account number. In some implementations, the potential customer and the accepted offer are tracked separately, such as using different methods or identifiers.

In some implementations, the processor may perform additional processing of the acceptance. For example, the processor may bill an account associated with the customer or indicate that the accepted service or product should be provided or shipped. In some cases, the processor may transmit the acceptance information to a separate processor for further processing. A messaging gateway may allow operators to define or model an activation flow and attach the same activation flow to multiple offers. The modeled activation flow may lead to faster or immediate activation after acceptance of the offer. After receiving an acceptance from a customer, the identifier may used to identify the offer, and the activation flow associated with the offer may be triggered to activate the acceptance of the offer, such as a purchase or subscription.

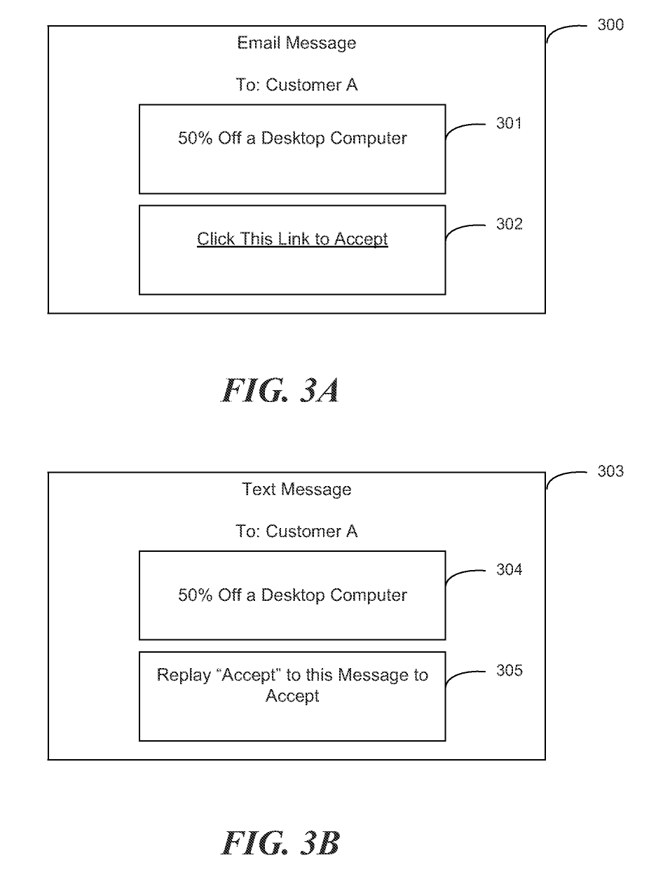

FIGS. 3A and 3B are diagrams illustrating examples of user interfaces for providing a promotional offer and a method of accepting the promotional offer. In FIG. 3A, an email message 300 includes text 301 describing a promotion and selectable item 302 for accepting the promotion. For example, the text 301 describes an offer for a coupon for 50% off of a desktop computer. The selectable item 302 provides a uniform resource locator link for a user to click to accept the offer and receive the coupon, such as to receive a coupon code. For example, the link may register the acceptance, lead to additional information about the offer, or confirm the user's acceptance.

In FIG. 3B, an SMS message 303 includes a promotion 304 and a method of acceptance 305. For example, the promotion 304 indicates an offer to provide a coupon for 50% off of a desktop computer. The method of acceptance 305 includes instructions to reply accept to the SMS message.

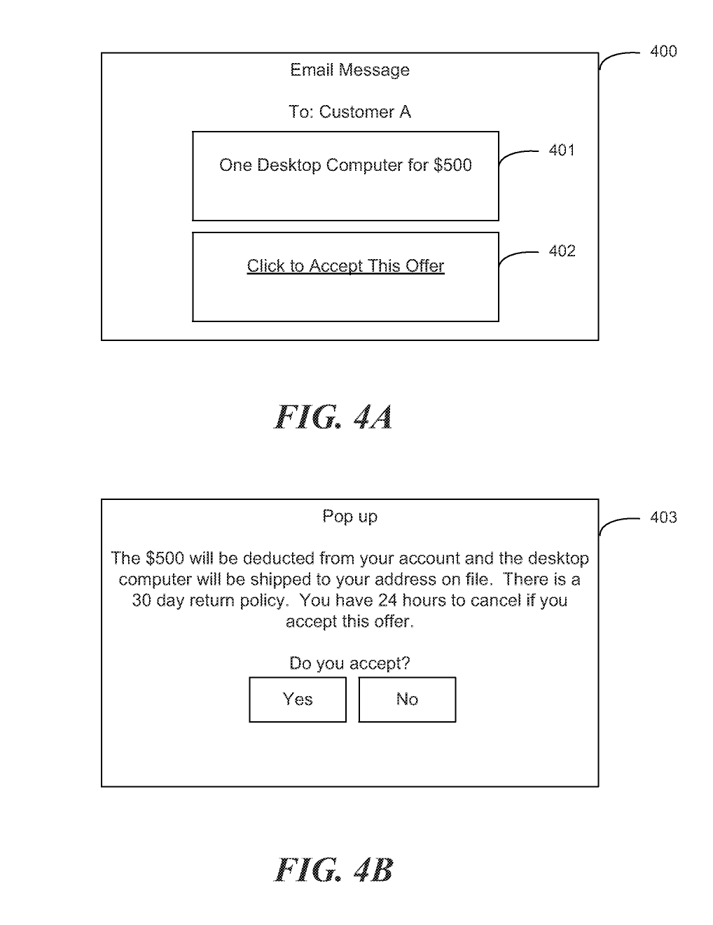

FIGS. 4A and 4B are diagrams illustrating examples of user interfaces for providing a promotional offer and a method of accepting the promotional offer. In FIG. 4A an email message includes text 401 describing an offer and a selectable item 402 indication a method of acceptance of the offer. The offer 401 includes text to describe an offer to sell one desktop computer for $500. The selectable item 402 includes a link that may be clicked to select the offer. FIG. 4B illustrates a pop up message 403 that appears when a user selects the selectable item 402. The pop up message 403 provides the potential customer more details about the offer and confirms that the potential customer accepts the offer.

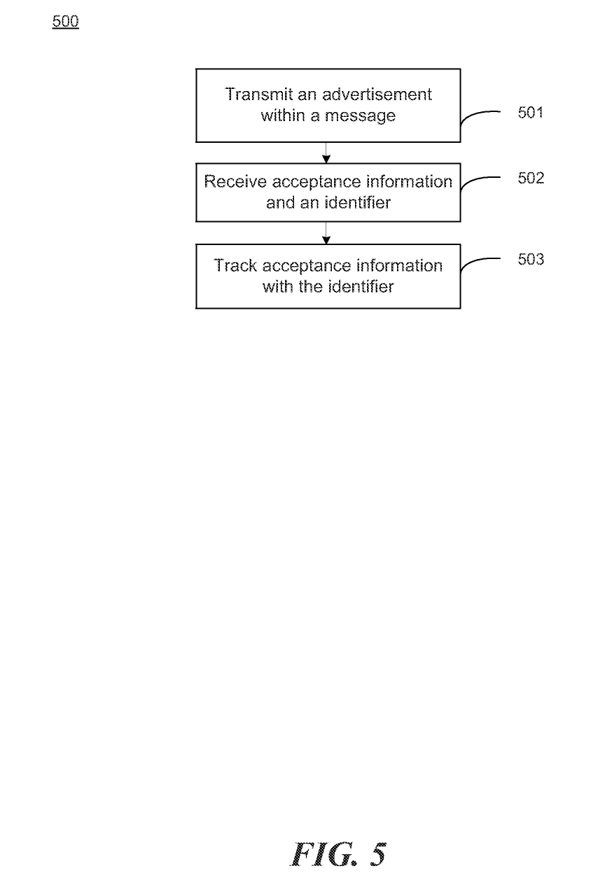

FIG. 5 is a flow chart 500 illustrating one example of a method to track an acceptance of an offer with an advertisement message. For example, a process may determine that an offer was accepted and which user account accepted it. Using an automatic method of tracking the acceptance may prevent the recipient from filling out large amounts of data to accept the offer.

Beginning at 501, a processor transmits an advertisement within a message. For example, the processor may include a unique identifier with the message. The processor may associate an advertisement identifier with an advertisement and store it in the database. The identifier may be linked to information about the advertisement and information about the potential customer, such as an advertisement agency, account number, and shipping address. This may prevent allow the system to later retrieve customer and advertisement information without receiving the information with a customer acceptance.

Moving to 502, the processor receives acceptance information and an identifier. The processor may send the advertisement with an identifier and an acceptance method may include the same identifier. For example, a link that a user clicks on may retain the identifier. As another example, an identifier may be captured from a user's electronic device when the user clicks on a link or replies to the advertisement message.

Continuing to 504, the processor tracks acceptance information with the identifier. For example, the processor may look up the identifier in the database to determine additional information about the acceptance, such as the details of the promotion and the customer. The database or other storage may include information about billing and other logistics. In some cases, the processor transmits the information to another system for further processing for billing, shipping, and other later steps. The tracking may be done to determine the effectiveness of an advertisement message or to further refine future advertisement messages.

Including a method of acceptance within an advertisement message may make a recipient of the advertisement message more likely to accept an offer presented in the advertisement message. An automatic tracking method of the advertisement acceptance may allow a recipient to easily accept the offer presented in the advertisement message without entering extensive additional information.

1. A method of advertising, comprising:
selecting, by a processor, an offer for a potential customer;
generating, by a processor, an advertisement message to include the selected offer and a manner for indicating an acceptance of the offer;
transmitting, by a processor, via a network the advisement message to a user account associated with the potential customer;
receiving, by a processor, via the network a response to the advertisement message indicating an acceptance of the offer; and
identifying, by a processor, the potential customer associated with the received response.

2. The method of claim 1, wherein the advertisement message comprises at least one of: an electronic mail message, a social networking message, or a short message service message.

3. The method of claim 1, wherein identifying the potential customer associated with the received response comprises identifying a mobile computing device sending the received response.

4. The method of claim 1, wherein the manner for indicating an acceptance comprises at least one of:
a selectable item within the advertisement; or
instructions for replying to a message containing the advertisement.

5. The method of claim 5, wherein the response comprises at least one of:
receiving a response to the message indicating an acceptance of the offer;
or
receiving an indication that an item within the advertisement was selected indicating an acceptance of the offer.

6. A machine-readable non-transitory storage medium comprising instructions executable by a processor, comprising instructions to:
determine a marketing offer to provide to a potential customer;
create a message including information about the determined offer and instructions for a type of reply to the message to accept the offer;
transmit the message to an account associated with the potential customer; and
capture an identifier related to a reply to the message indicating an acceptance of the offer.

7. The machine-readable non-transitory storage medium of claim 6, further comprising instructions to process the accepted offer.

8. The machine-readable non-transitory storage medium of claim 6, wherein the method to accept the offer comprises at least one of: replying to the message with a reply code provided within the message, clicking on a uniform resource locator within the message, or selecting a button on a phone keypad.

9. The machine-readable non-transitory storage medium of claim 6, wherein the message comprises at least one of an electronic mail message, a social network message, phone voice message, or a short message service message.

10. The machine-readable non-transitory storage medium of claim 6, wherein capturing an identifier of an electronic device accepting the offer comprises capturing a Mobile Subscriber Integrated Services Digital Network Number of an electronic device accepting the offer.

11. An electronic device, comprising:
a processor to generate an advertisement message including:
a description of a promotion;
a selectable item within the advertisement for indicating an acceptance of the promotion described in the text, and
an identifier associated with the advertisement to identify a user to receive the advertisement.

12. The electronic device of claim 11, wherein the selectable item comprises a uniform resource identifier.

13. The electronic device of claim 11, wherein the promotion comprises a promotion for purchasing a product or service.

14. The electronic device of claim 11, wherein the processor provides additional information about the promotion when the selectable item is selected.

15. The electronic device of claim 11, wherein the identifier comprises an identifier of an electronic device to receive the advertisement.
